(19) United States
(12) Patent Application Publication
(10) Pub. No.: US 2015/0048637 A1
(43) Pub. Date: Feb. 19, 2015

(54) DEVICE FOR COLLECTING PET WASTE

(71) Applicant: Rafael Yoachim FIDLER, Rishon Lezion (IL)

(72) Inventor: Rafael Yoachim Fidler, Rishon Lezion (IL)

(21) Appl. No.: 14/379,930

(22) PCT Filed: Mar. 12, 2013
(86) PCT No.: PCT/IL2013/050226

§ 371 Date: Aug. 20, 2014

(30) Foreign Application Priority Data
Mar. 14, 2012 (IL) 218638

(51) Int. Cl. A01K 1/01; B07B 1/02

(52) U.S. Cl. CPC A01K 1/01; B07B 1/02
USPC 294/1.3

(57) ABSTRACT

The present invention is relates to a device for collecting pet's waste out of a litter box, which comprises a collecting basket, said basket having a handle and an essentially rounded portion, such that said portion spanning in cross section more than 90 degrees of a peripheral of circle sector, wherein said basket having a proximate end to which said handle is attached and a distal end adapted to be immersed within said litter box.

### FIELD OF THE INVENTION

The present invention relates to the field of tools for pets. More particularly, the invention relates to a cat litter scoop for removing waste material from a cat litter container.

### BACKGROUND OF THE INVENTION

One task involved in caring for a house cat is cleaning the cat litter container known as litter box or sandbox. The waste material must regularly be separated from the cat litter.

Typical cat litter scoop includes a handle portion and a base or basket portion. The base portion may contain openings in either a slot or mesh structure through which the cat litter can be filtered. For example, U.S. Pat. D480519 shows a typical scoop for the sifting and removal of pet waste, designed for casting from a suitable metal or similar material (see FIG. 5).

The cat litter scoop provides for a clumping action with waste material in a cat litter container to form what is called “clumped material.” In order to use a cat litter scoop, the clumped material and clean cat litter is scooped into the base or basket portion. The scoop is then shaken to separate the clumped material from the clean litter such that the clean litter falls through the openings. The solid waste material remaining in the scoop is then discarded. However, the prior art scoops and their way of operation suffer from a major drawback, as due to their structure it is become a time consuming task to clean the entire litter box. The user is required to immersed the scoop in the litter and then to raise it up and shake it, and then to repeat these actions for many times over every spot in the litter box.

To overcome this drawback and to allow users to more easily cleaning the litter box, an enhanced scoop is required.

It is an object of the present invention to provide a scoop like device which is capable of cleaning the entire litter box in a relatively short time and with fewer actions with respect to the prior-art scoops while eliminating the need to raise up and shake the scoop.

It is an object of the present invention to provide a scoop like device which eliminates the need to search for pet waste within a litter box, but to clean a relatively large area within the litter box with a single action.

Other objects and advantages of the invention will become apparent as the description proceeds.

### SUMMARY OF THE INVENTION

The present invention is relates to a device for collecting pet's waste out of a litter box, which comprises a collecting basket, said basket having a handle and an essentially rounded portion, such that said portion spanning in cross section more than 90 degrees of a peripheral of circle sector, wherein said basket having a proximate end to which said handle is attached and a distal end adapted to be immersed within said litter box.

According to an embodiment of the invention, the collecting basket is an openwork basket portion having one or more regions which are angled with respect to the handle.

According to an embodiment of the present invention, the one or more regions are rounded or having an arc-like shape, thus they are angled with respect to the handle in such a way that the proximate end of the basket (i.e., the end to which the handle is attached) is essentially facing the distal end of said basket.

According to an embodiment of the present invention, the openwork basket portion is formed of a plurality of rigid bars that forms a grating-like angled or curved structure with respect to the handle.

According to an embodiment of the invention, the device further comprises one or more strengthening bars connected across the rigid bars for strengthening the structure of the basket.

According to an embodiment of the invention, the basket further comprises two openwork side wall portions each of which perpendicularly attached to one of the two opposite sides of the basket with respect to an axis that crosses the width of said basket between said opposite sides, for preventing from the collected cat's waste to slip or fall out from the side of said basket.

According to an embodiment of the invention, the device further comprises a scarping element connected across the width of the distal end of the basket.

According to an embodiment of the invention, the device further comprises a designed element attached to the surface of the one or more regions of the basket.

According to an embodiment of the invention, the handle is adapted for being grasped by a hand of a user such that it will allow the user to easily collect the waste by operating the device in a raking-like form.

### BRIEF DESCRIPTION OF THE DRAWINGS

In the drawings:

FIG. 1 schematically illustrates a side view of a device in form of a scoop for cat litter, according to an embodiment of the present invention;

FIG. 2 schematically illustrates a top view of the device of FIG. 1;

FIG. 3 schematically illustrates a perspective view of the device of FIG. 1;

FIG. 4 schematically illustrates the device of FIG. 1 and the required orientation for using it with respect to a litter box, according to an embodiment of the present invention; and

FIG. 5 schematically illustrates a typical cat litter scoop, according to the prior-art

### DETAILED DESCRIPTION OF THE INVENTION

Throughout this description the term “litter box” is used to indicate a container adapted to hold particulate solid material, such as cat litter. This term does not imply any particular shape, construction material or geometry, and invention is applicable to all suitable particulate solid containers.

The present invention relates to a cat litter tool in form of a scoop which is adapted to extract or collect cat's waste out of the cat litter within a litter box. According to some embodiments of the invention, the device comprises: a) a handle adapted for being grasped by a hand of a user; and b) an openwork basket portion having one or more regions which are angled with respect to the handle.

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

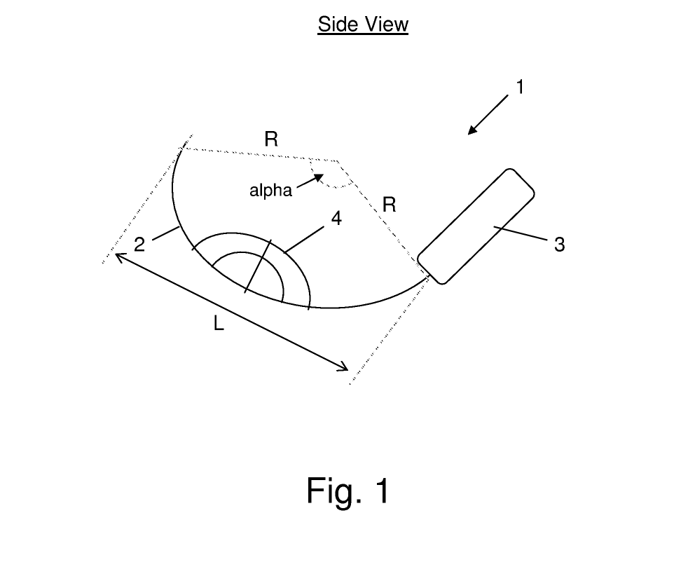

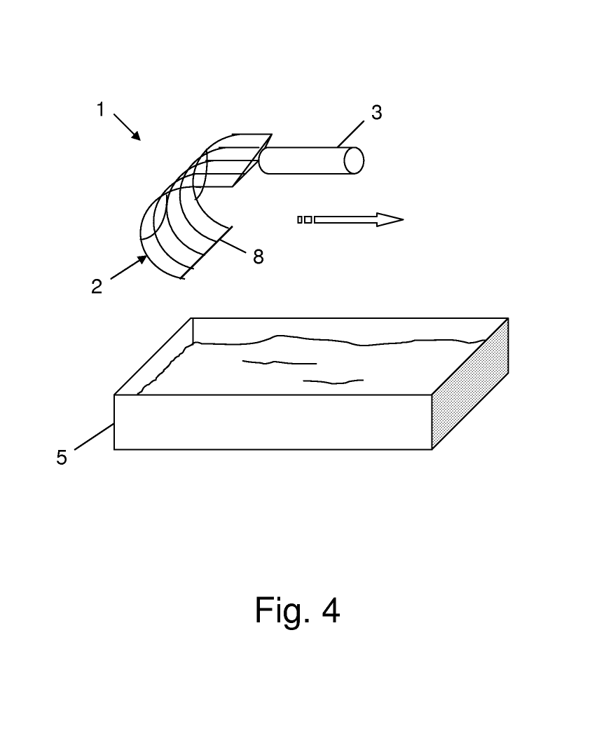

FIGS. 1-3 show a device 1 having a scoop like form, according to an embodiment of the present invention. Device 1 can be used as a cat litter tool. Device 1 comprises an openwork basket portion 2 and a handle 3. The basket portion 2 is made of rigid material (e.g., metal or plastic) so that it does not flex when scraping a cat litter box. The basket portion 2 is having one or more regions which are angled with respect to handle 3. This structure provides a comfortable grip and wrist position for ease manipulating, while it simplifies the scooping action (as described in further details hereinafter with respect to FIG. 4). The handle 3 is contoured to fit a user's hand for comfort and stability (e.g., the handle 3 may have a rounded-like form).

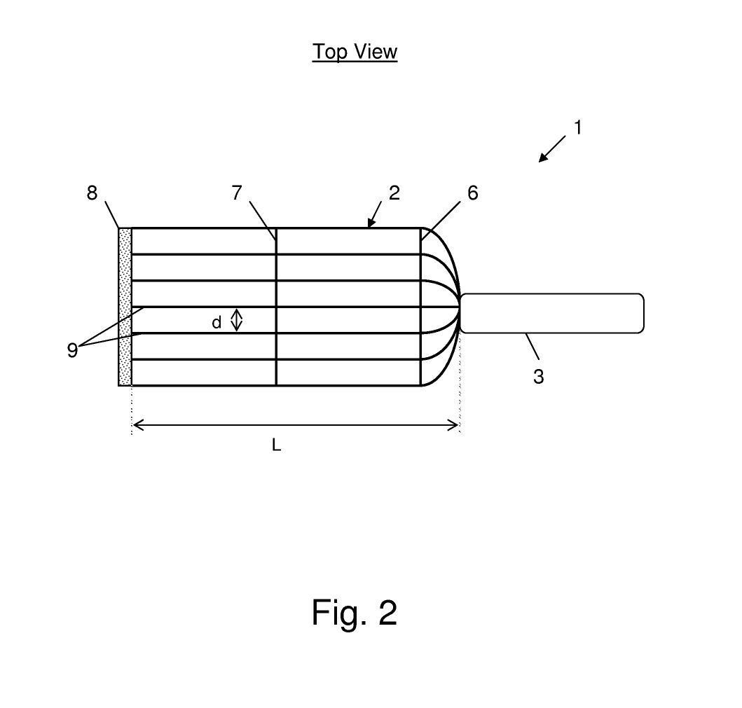

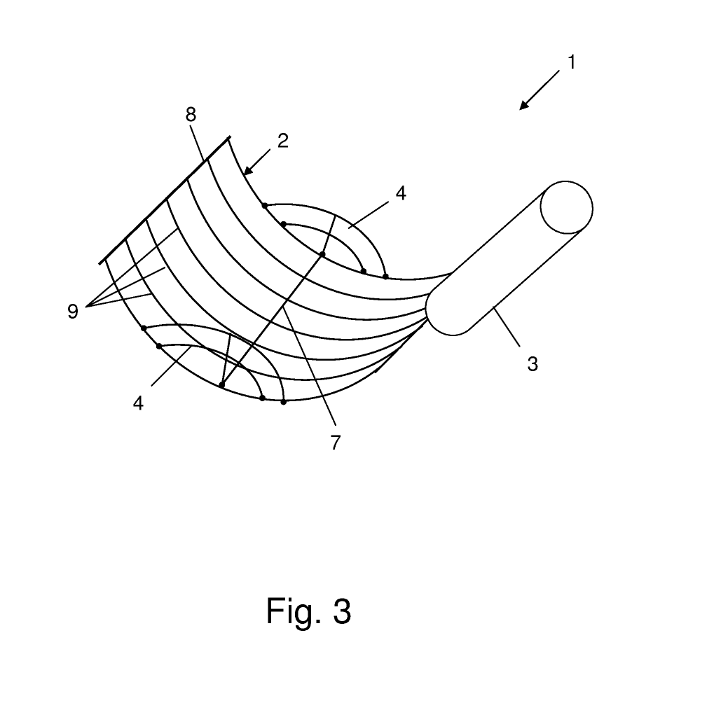

FIGS. 1-3 show different views of device 1, with suitable dimensions. FIG. 1 shows a side view of handle 3 and the basket portion 2, together with the openwork side wall portion 4. FIG. 2 shows a top view of handle 3 and the grating-like shape of the basket portion 2, as well as the absolute distance (d) between the bars 9 the forms the grating-like shape. FIG. 3 shows a perspective view of device 1. In this embodiment, the openwork side wall portions 4 are in the form of a grating-like window, in order to prevent the collected cat's waste from falling out from the sides of basket portion 2.

According to an embodiment of the present invention, the one or more regions of the basket portion 2 are rounded or having an arc-like shape, thus with respect to the handle 3 they are angled in such a way that the proximate end of the basket portion 2 (to which the handle 3 is attached) is essentially facing the distal end of the basket portion 2.

According to this embodiment of the invention, the openwork basket portion 2 is formed of a plurality of rigid and thin bars (as indicated by numeral 9 in FIGS. 2 and 3) to promote a raking action. The distance (d) between each adjacent bars 9 having an absolute value that is determined according to the average size of cat's waste (e.g., “d” is about 1 cm). For example, in case the number of rigid bars is 11, then the width of the basket portion 2 will be about 12 cm, whenever the distance between adjacent bars is about 1 cm. As will be appreciated by the skilled person, the basket portion 2 can be provided in a variety of sizes each adapted to collect waste of smaller or larger cats (e.g., for smaller cats, such as kittens, “d” can be less than 1 cm). In this embodiment, the openwork basket portion 2 is formed of a plurality of rigid bars that forms a grating-like angled or curved structure with respect to the handle 3.

According to an embodiment of the invention, the basket portion 2 further comprises one or more strengthening bars (as indicated by numerals 6, 7 and 8 in FIG. 2) each of which crosses the rigid bars 9 and connects them for strengthening the structure of the basket portion 2.

According to an embodiment of the invention, device 1 further comprises a scarping element connected across the width of the distal end of the basket portion 2. For example, the strengthening bar located across the distal edge of the basket portion 2 (as indicated by numeral 8) can be wider then the other strengthening bars 6 and 7 (e.g., bar 8 can have a width of about 7-10 mm and a minimal outer edge), thereby providing the distal edge of the basket portion 2 an enhanced scarping abilities and/or an enhanced mobility while being immersed within the cat litter inside a litter box.

The basket portion 2 may further comprise two openwork side wall portions (indicated by numeral 4) each of which perpendicularly attached to one of the two opposite sides of the basket portion 2 with respect to an axis that crosses the width of the basket portion 2 (e.g., such an axis can be demonstrated by the strengthening bar 7 that crosses the width of the basket portion 2 between its two opposite sides, as can be easily seen in FIG. 3). The openwork side wall portions can prevent from the collected cat's waste to slip or fall out from the sides of the basket portion 2.

According to an embodiment of the invention, the basket portion 2 having an essentially rounded shape, which spans in cross section more than 90 degrees of a peripheral of circle sector (as indicated by the angle “alpha” and the dotted lines that defined the radiuses “R” in FIG. 1). For example, the basket portion 2 can be curved in such a way that its diameter (or its transverse diameter—in case of an ellipse-like shape) is from about 10 cm to about 30 cm. Accordingly, the length of the arc can be between 15 cm to about 30 cm, while the angle (alpha) as defined by the radius (R) and the proximate and distal ends or edges of the basket portion 2 (as shown in FIG. 1) is more than 90 degrees (e.g., can be about 160-200 degrees).

According to an embodiment of the invention, the basket portion 2 having an essentially rounded shape, which spans in cross section more than 120 degrees of a peripheral of circle sector. According to some embodiments of the invention, the basket portion 2 having an essentially rounded shape, which spans in cross section more than 150 degrees of a peripheral of circle sector.

In some embodiments, the rounded shape of the basket portion 2 is defined by the angle (alpha) and the length (L) between the edges of the basket portion 2 (e.g., the angle alpha can be about 170 degrees while the length L is about 18 cm).

According to an embodiment of the invention, the length (L) of basket 2 is about two times larger than its width (i.e., the ratio between the length and the width of basket 2 is about 2:1).

The openwork basket portion 2 as descried in the figures is having a single rounded region which is angled with respect to the handle 3 of device 1. As aforementioned hereinabove, the basket portion 2 may have more than one region. In such case each region is angled with respect to the other regions thus they forming an angled structure of the basket portion or an arc-like shape. As will be appreciated by the skilled person, in case that the basket portion is having two or more regions, each region can be essentially flat.

Although, the rounded shape of the basket portion 2 is described in the figures with respect to a circle, the rounded shape can also be defined according to an ellipsoid form or other forms of curved angled forms, as will be apparent to the skilled person.

All these aforementioned arrangements obviate disadvantages of existing cat litter scoops as will be further described hereinafter.

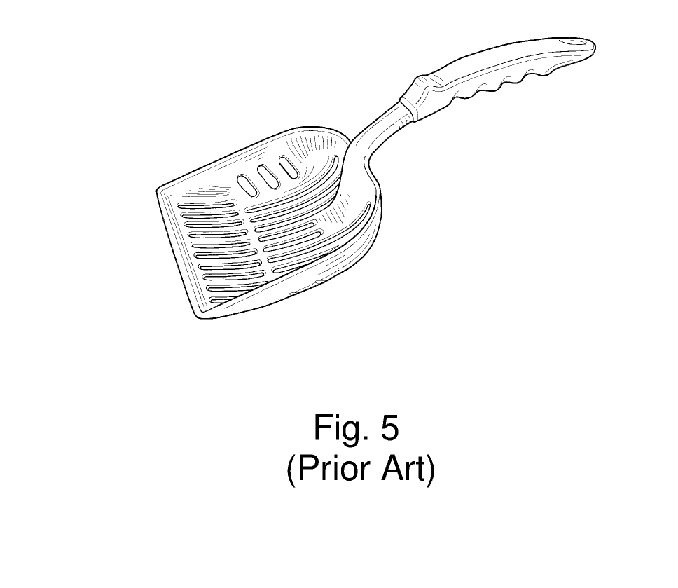

In contradiction to prior-art scoops, the device 1 of the present invention is designed to operate in such a way that the basket portion 2 is facing down with respect to the surface of a litter box (as shown in FIG. 4 with respect to a litter box 5). The unique curved structure of device 1 allows performing a raking-like action, starting at the distal end of the litter box 5, and ending after completing the dragging of the device 1 along the length of the litter box 5. At the end of this single dragging action, only the cat's waste remain in the inner side of the basket portion 2 (mostly in the middle section of the basket portion 2 at the area defined by its sides potions as indicated by numeral 4). Moreover, using the cat litter tool of the present no frustrating shaking actions are needed, as do required with prior-art cat litter scoops. A typical prior-art cat litter scoop is shown in FIG. 5.

According to some embodiments of the present invention, the device 1 further comprises a designed element (e.g., a flat and rigid object carrying a brand name or logo) attached to the surface of the one or more regions of the openwork basket portion 2 (e.g., a label-like element attached to the rigid bars of the basket portion 2).

As will be appreciated by the skilled person the arrangement described in the figures results in a simple set of one time actions of rake and lift, such that the entire waste along the raking path of the device 1 is collected in one single raking action, which makes it possible to effectively clean the entire litter box with minimal effort. This process (i.e., the raking and lifting of device 1) requires about two or three raking actions along the length of the litter box, and it directly depends on the geometrical proportions between the widths of the litter box and device 1.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A device for collecting pet's waste out of a litter box, which comprises a collecting basket, said basket having a handle and an essentially rounded portion, such that said portion spanning in cross section more than 90 degrees of a peripheral of circle sector, wherein said basket having a proximate end to which said handle is attached and a distal end adapted to be immersed within said litter box.

2. A device according to claim 1, in which the collecting basket is an openwork basket portion having one or more regions which are angled with respect to the handle.

3. A device according to claim 1, in which the handle is adapted for being grasped by a hand of a user such that it will allow the user to collect the cat's waste while operating the device in a raking-like form.

4. A device according to claim 2, in which the one or more regions are rounded or having an arc-like shape and they are angled with respect to the handle in such a way that the proximate end of the basket, to which the handle is attached, is essentially facing the distal end of said basket.

5. A device according to claim 1, in which the collecting basket is formed of a plurality of rigid bars that forms a grating-like angled or curved structure with respect to the handle.

6. A device according to claim 5, further comprising one or more strengthening bars connected across the plurality of rigid bars for strengthening the structure of the basket.

7. A device according to claim 1, in which the basket further comprises two openwork side wall portions each of which perpendicularly attached to one of the two opposite sides of said basket with respect to an axis that crosses its width between said opposite sides.

8. A device according to claim 1, further comprising a scarping element connected across the width of the distal end of the basket.

9. A device according to claim 1, further comprising a designed element attached to the surface of the one or more regions of the basket portion.

10. A device according to claim 1, in which the ratio between the length and the width of the basket is about 2:1.
